(19) United States
(12) Patent Application Publication
(10) Pub. No.: US 2026/0245803 A1
(43) Pub. Date: Aug. 20, 2026

(54) MULTILAYER ELECTRONIC COMPONENT

(71) Applicant: SAMSUNG ELECTRO-MECHANICS CO., LTD., Suwon-si (KR)

(72) Inventor: Eun Yong JANG, Suwon-si (KR)

(73) Assignee: SAMSUNG ELECTRO-MECHANICS CO., LTD., Suwon-si (KR)

(21) Appl. No.: 19/440,803

(22) Filed: Jan. 6, 2026

(30) Foreign Application Priority Data
Feb. 19, 2025 (KR) 10-2025-0021479

(51) Int. Cl. H01G 4/30; H01G 4/012; H01G 4/232; H01G 4/12

(52) U.S. Cl. CPC H01G 4/30; H01G 4/012; H01G 4/232; H01G 4/1227; H01G 4/1245

(57) ABSTRACT

A multilayer electronic component includes a body including a dielectric layer and internal electrodes alternately disposed with the dielectric layer in a thickness direction, and including first and second surfaces opposing each other in the thickness direction, and third and fourth surfaces connected to the first and second surfaces and opposing each other in a length direction; protrusions disposed on the first and second surfaces, respectively; and external electrodes disposed on the third and fourth surfaces, respectively, and extending to the protrusions, wherein the external electrode includes an electrode layer connected to the internal electrode, and a conductive resin layer disposed on the electrode layer and including a conductive metal and resin, and wherein the electrode layer is spaced apart from the protrusion, and the conductive resin layer is disposed to be in contact with the protrusion.

### CROSS-REFERENCE TO RELATED APPLICATION(S)

The application claims benefit of priority to Korean Patent Application No. 10-2025-0021479 filed on February 19, 2025 in the Korean Intellectual Property Office, the disclosure of which is incorporated herein by reference in its entirety.

### BACKGROUND

### Technical Field

The present disclosure relates to a multilayer electronic component.

### Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Also, recently, the interest in the automotive electrical components has increased, a multilayer ceramic capacitor has also been required to have high reliability and high strength properties for use in vehicles or an infotainment system.

To ensure high reliability and high strength properties, a general external electrode structure may be replaced with a double-layer structure including an electrode layer and a conductive resin layer.

As for the double-layer structure including an electrode layer and a conductive resin layer, by applying a resin composition containing a conductive material to an electrode layer, external impacts may be absorbed and penetration of plating solution may be prevented, thereby improving reliability.

However, as industry standards for high reliability and high strength properties have become increasingly stringent, the development of a multilayer electronic component having improved high reliability and high strength properties may be necessary.

### SUMMARY

An embodiment of the present disclosure is to provide a multilayer electronic component having improved warpage strength.

An embodiment of the present disclosure is to provide a multilayer electronic component in which cracks are suppressed.

An embodiment of the present disclosure is to provide a multilayer electronic component having improved capacitance per unit volume.

According to an embodiment of the present disclosure, a multilayer electronic component includes a body including a dielectric layer and internal electrodes alternately disposed with the dielectric layer in a thickness direction, the body including first and second surfaces opposing each other in the thickness direction, third and fourth surfaces connected to the first and second surfaces and opposing each other in a length direction, and fifth and sixth surfaces connected to the first to fourth surfaces and opposing each other in a width direction; a protrusion disposed on the first and second surfaces; and an external electrode disposed on the third and fourth surfaces, and extending to the protrusions, wherein the external electrode includes an electrode layer connected to the internal electrodes, and a conductive resin layer disposed on the electrode layer, the conductive resin layer including a conductive metal and resin, and wherein the electrode layer is spaced apart from the protrusion, and the conductive resin layer is disposed to be in contact with the protrusion.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a diagram illustrating the multilayer electronic component illustrated in FIG. 1, in which external electrodes are not provided;

FIG. 3 is a diagram illustrating the multilayer electronic component illustrated in FIG. 2, in which a protrusion is not provided;

FIG. 4 is a cross-sectional diagram taken along line I-I’ in FIG. 1;

FIG. 5 is a cross-sectional diagram taken along line II-II’ in FIG. 1;

FIG. 6 is an exploded diagram illustrating a body and a protrusion according to an embodiment of the present disclosure;

FIG. 7 is an enlarged diagram illustrating region K1 in FIG. 4;

FIG. 8 is a diagram corresponding to FIG. 7 according to an embodiment of the present disclosure;

FIG. 9 is a diagram corresponding to FIG. 7 according to another embodiment of the present disclosure;

FIG. 10 is a diagram corresponding to FIG. 7 according to another embodiment of the present disclosure; and

FIG. 11 is a diagram corresponding to FIG. 4, to which a dummy electrode is added, according to an embodiment of the present disclosure.

### DETAILED DESCRIPTION

Hereinafter, embodiments of the present disclosure will be described as below with reference to the accompanying drawings.

The embodiments of the present disclosure may be modified in various different forms, and the scope of the present disclosure is not limited to the embodiments described below. Also, the embodiments of the present disclosure are provided to more fully describe the present disclosure to those skilled in the art. Accordingly, the shapes and sizes of elements in the drawings may be exaggerated for clarity, and elements indicated by the same reference numerals in the drawings are identical elements.

In the drawings, to clearly describe the present disclosure in the drawings, irrelevant parts may be omitted, and the size and thickness of each component in the drawings have been arbitrarily indicated for ease of description, and thus, the present disclosure is not necessarily limited thereto. Also, the terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the X direction may be defined as the first direction, the lamination direction or the thickness T direction, the Y direction may be defined as the second direction or the length L direction, and the Z direction may be defined as the third direction or the width W direction. The length of the multilayer electronic component may be greater than the width, but an embodiment thereof is not limited thereto, and the length and width of the multilayer electronic component may be equal, or the length of the multilayer electronic component may be less than the width. Also, the thickness direction of the multilayer electronic component may coincide with the lamination direction of the dielectric layer and the internal electrode, but an embodiment thereof is not limited thereto, and the lamination direction of the dielectric layer and the internal electrode may be in the width direction.

### Multilayer Electronic Component

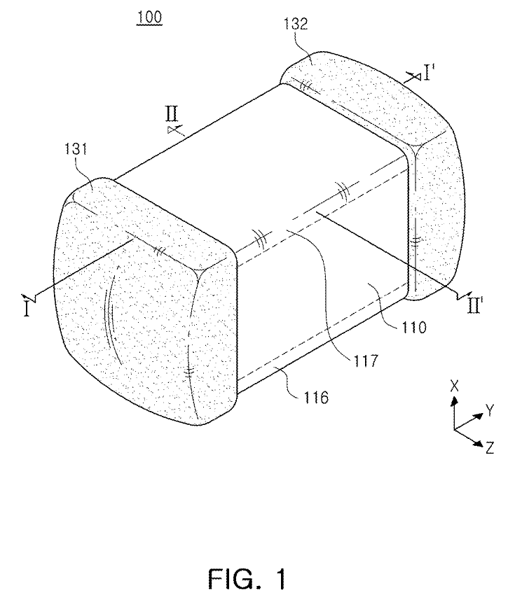

FIG. 1 is a perspective diagram illustrating a multilayer electronic component according to an embodiment.

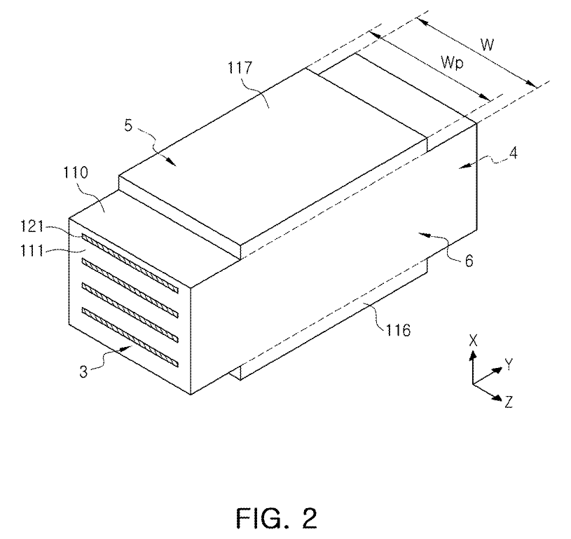

FIG. 2 is a diagram illustrating the multilayer electronic component illustrated in FIG. 1, in which external electrodes are not provided.

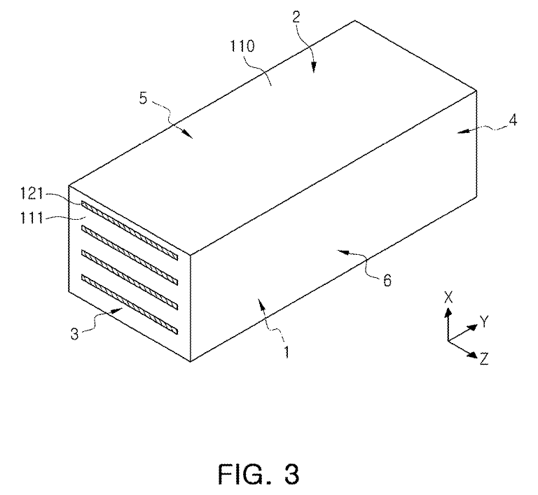

FIG. 3 is a diagram illustrating the multilayer electronic component illustrated in FIG. 2, in which a protrusion is not provided.

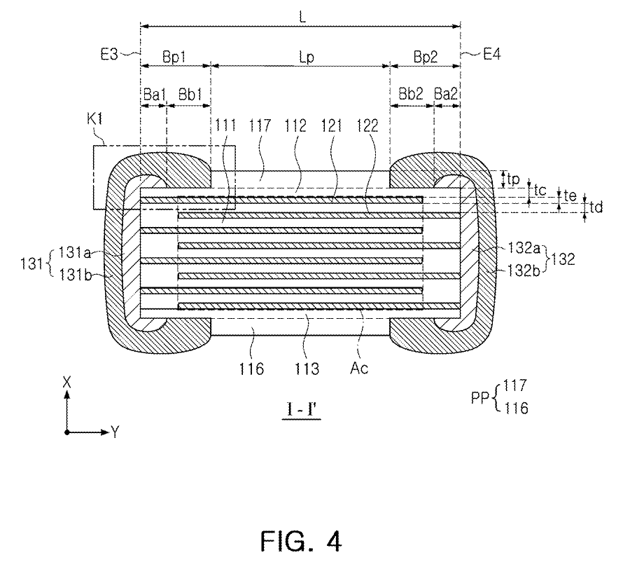

FIG. 4 is a cross-sectional diagram taken along line I-I’ in FIG. 1.

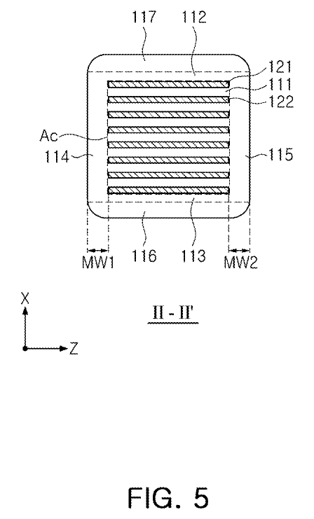

FIG. 5 is a cross-sectional diagram taken along line II-II’ in FIG. 1.

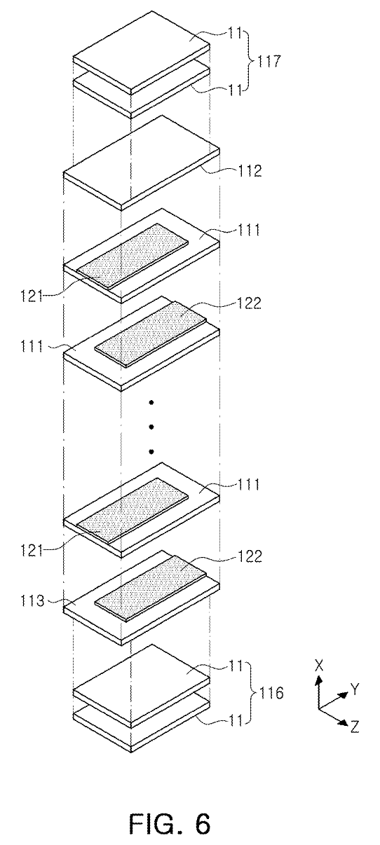

FIG. 6 is an exploded diagram illustrating a body and a protrusion according to an embodiment.

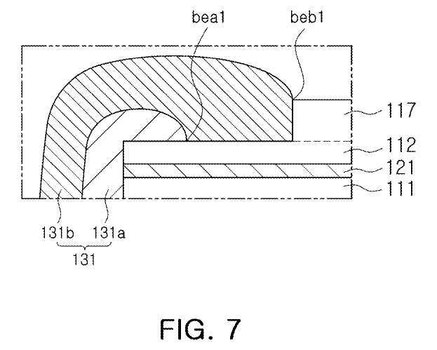

FIG. 7 is an enlarged diagram illustrating region K1 in FIG. 4.

Hereinafter, a multilayer electronic component 100 according to an embodiment of the present disclosure will be described in detail with reference to FIGS. 1 to 7. Also, a multilayer ceramic capacitor (hereinafter referred to as “MLCC”) is described as an example of the multilayer electronic component, but an embodiment thereof is not limited thereto, and may be applied to various multilayer electronic components using a ceramic material, such as an inductor, piezoelectric element, varistor, or thermistor.

A multilayer electronic component according to an embodiment of the present disclosure may include a body 110 including a dielectric layer 111 and internal electrodes 121 and 122 alternately disposed with the dielectric layer in a thickness direction, and including first and second surfaces 1 and 2 opposing each other in the thickness direction, third and fourth surfaces 3 and 4 connected to the first and second surfaces and opposing each other in a length direction, and fifth and sixth surfaces 5 and 6 connected to the first to fourth surfaces and opposing each other in a width direction; protrusions PP disposed on the first and second surfaces, respectively; and external electrodes 131 and 132 disposed on the third and fourth surfaces, respectively, and extending into the protrusions, wherein the external electrode includes electrode layers 131a and 132a connected to the internal electrodes and conductive resin layers 131b and 132b disposed on the electrode layers, and including conductive metal and resin, and wherein the electrode layers 131a and 132a are spaced apart from the protrusions 116 and 117, and the conductive resin layers 131b and 132b are disposed to be in contact with the protrusions 116 and 117.

Warpage stress applied to typical multilayer electronic components occurs most significantly in the region in which an end of the band portion of the external electrode is in contact with the body, and cracks may be formed in this region. In the multilayer electronic component in the related art, the region in which the end of the band portion of the external electrode is in contact with the body may be formed of a fragile dielectric material, such that cracks may easily occur.

According to the embodiment, by filling the region in which warpage stress occurs most with a conductive resin layer, warpage strength may be improved and cracks may be suppressed.

In the description below, each of the components included in the multilayer electronic component 100 according to an embodiment of the present disclosure will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

The plurality of dielectric layers 111 included in the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, and a binder, applying and drying the slurry on a carrier film to prepare a ceramic green sheet, and sintering the ceramic green sheet. The ceramic powder is not limited to any particular example as long as sufficient electrostatic capacitance may be obtained, but for example, a barium titanate-based (BaTiO₃) powder may be used as the ceramic powder. For more specific examples, the ceramic powder may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1).

The average thickness td of the dielectric layer 111 may not be limited to any particular example, and may be, for example, 0.3 to 500 μm, but an embodiment thereof is not limited thereto, and the average thickness td of the dielectric layer 111 may be arbitrarily determined depending on desired properties or applications.

Here, the average thickness td of the dielectric layer 111 may indicate the size in the first direction of the dielectric layer 111 disposed between the internal electrodes 121 and 122. The average thickness, td, of the dielectric layer 111 may be measured by scanning the cross-section in the first and second direction of the body 110 using a scanning electron microscope (SEM) at 10,000x magnification. More specifically, the thickness of multiple points of the single dielectric layer 111, for example, 30 points spaced apart by an equal distance in the second direction, may be measured, and the average value may be determined. The 30 points spaced apart by an equal distance may be designated in the capacitance formation portion Ac described below. Also, by measuring thicknesses of 10 dielectric layers 111 and measuring the average value, the average thickness of the dielectric layer 111 may be further generalized.

The body 110 may include a capacitance formation portion Ac in which the dielectric layer 111 and the internal electrodes 121 and 122 are alternately disposed in the thickness direction, and cover portions 112 and 113 disposed above and below the capacitance formation portion in the thickness direction, respectively.

The capacitance formation portion Ac may be disposed in the body 110 and includes a first internal electrode 121 and a second internal electrode 122 disposed so as to oppose each other with the dielectric layer 111 interposed therebetween, thereby forming capacitance.

Also, the capacitance formation portion Ac may be a portion contributing to the capacitance formation of the capacitor, and may be formed by repeatedly laminating the plurality of first and second internal electrodes 121 and 122 with the dielectric layer 111 interposed therebetween.

The cover portions 112 and 113 may include an upper cover portion 112 disposed above the capacitance formation portion Ac in the thickness direction and a lower cover portion 113 disposed below the capacitance formation portion Ac in the thickness direction.

In an embodiment, when the average thickness of the cover portions 112 and 113 is defined as tc, tc may be 10 μm or more and 200 μm or less.

In an embodiment, when the average thickness of the dielectric layer 111 is defined as td and the average thickness of the cover portions 112 and 113 is defined as tc, tc/td may be 0.4 or more and 10 or less.

The average thickness tc of the cover portions 112 and 113 may be the average value of the thicknesses in the first direction, measured at 10 arbitrary points of the upper cover portion 112 or the lower cover portion 113 in the cross-section in the first and second direction.

The upper cover portion 112 and the lower cover portion 113 may not include an internal electrode and may include the same material as that of the dielectric layer 111.

That is, the upper cover portion 112 and the lower cover portion 113 may include a ceramic material, for example, a barium titanate (BaTiO₃) ceramic material.

Also, the margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces in the width direction of the body 110.

The margin portions 114 and 115 may indicate a region between both ends of the first and second internal electrodes 121 and 122 and the boundary surface of the body 110 in a cross-section in the width-thickness (W-T) direction of the body 110 as illustrated in FIG. 3.

The margin portions 114 and 115 may basically prevent damage to the internal electrode due to physical or chemical stress.

The margin portions 114 and 115 may be formed by forming an internal electrode by applying a conductive paste on the ceramic green sheet other than the region in which the margin portion is to be formed.

Also, to prevent a step difference caused by the internal electrodes 121 and 122, after laminating, the margin portion 114 and 115 may be formed by cutting the internal electrode to be exposed to the fifth and sixth surfaces 5 and 6 of the body, and laminating a single dielectric layer or two or more dielectric layers on both side surfaces of the capacitance formation portion Ac in the third direction (width direction).

Widths of the margin portions 114 and 115 may not be limited to any particular example. The average width of the margin portions 114 and 115 may be 180 μm or more and 1.1 mm or less.

The average width of margin portions 114 and 115 may refer to the average size MW1 in the third direction of the region in which the internal electrode is spaced apart from the fifth surface and the average size MW2 in the third direction of the region in which the internal electrode is spaced apart from the sixth surface, and may be the average value of the sizes in the third direction of the margin portions 114 and 115 measured at five points at an equal distance on the side surface of the capacitance formation portion Ac.

Accordingly, in an embodiment, each of the average sizes MW1 and MW2 in the third direction of the region spaced apart from the fifth and sixth surfaces of the internal electrodes 121 and 122 may be 180μm or more and 1.1 mm or less.

The internal electrodes 121 and 122 may include first and second internal electrodes 121 and 122. The first and second internal electrodes 121 and 122 may be alternately disposed to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. Also, the first external electrode 131 may be disposed on the third surface 3 of the body and may be connected to the first internal electrode 121, and the second external electrode 132 may be disposed on the fourth surface 4 of the body and the be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

The method of forming the internal electrodes 121 and 122 is not limited to any particular example. For example, the internal electrodes 121 and 122 may be formed by applying a conductive paste for the internal electrode containing a conductive metal onto a ceramic green sheet and firing the paste. As the method of applying the conductive paste for the internal electrode, a screen printing method or a gravure printing method may be used, but an embodiment thereof is not limited thereto.

As another example, the internal electrodes 121 and 122 may also be formed using a sputtering method, a vacuum deposition method, and/or a chemical vapor deposition method.

The average thickness te of the internal electrode may not be specifically limited. In this case, the thickness of the internal electrodes 121 and 122 may indicate the size in the first direction of the internal electrodes 121 and 122. For example, the average thickness te of internal electrodes 121 and 122 may be 0.3 to 4.0 μm.

The average thickness te of the internal electrodes 121 and 122 may be measured by scanning the cross-sectional surface in the first and second directions of the body 110 using a scanning electron microscope (SEM) at 10,000x magnification. More specifically, the thickness may be measured at multiple points of one of the internal electrodes 121 and 122, for example, 30 points at equal distances in the second direction, and the average value may be measured. The 30 points at equal distances may be designated as the capacitance formation portion Ac. Also, by measuring the average value of 10 internal electrodes 121 and 122, the average thickness of the internal electrodes 121 and 122 may be further generalized.

The protrusion PP may be disposed on the first and second surfaces 1 and 2 of body 110, respectively. A lower protrusion 116 may be disposed on the first surface of body 110, and an upper protrusion 117 may be disposed on the second surface of body 110. In the description below, the upper protrusion 117 disposed on the second surface will be described, but as the protrusion 116 disposed on the first surface is symmetrical with the protrusion 117 disposed on the second surface in the X direction, the same description may also be applied to the protrusion 116 disposed on the first surface.

The protrusion PP may prevent damage to the internal electrodes 121 and 122 due to physical or chemical stress.

The electrode layers 131a and 132a may be spaced apart from the protrusions 116 and 117, and the conductive resin layers 131b and 132b may be in contact with the protrusions 116 and 117. Accordingly, by filling the region in which warpage stress occurs the most with the conductive resin layers 131b and 132b, warpage strength may be improved and cracks may be suppressed.

In an embodiment, when the length of the body is defined as L, the length of the protrusion is defined as Lp, and the length of the region of the second surface, in contact with the conductive resin layer, is defined as Bb, 0.4 ≤ Lp/L ≤ 0.7 and 0.1 ≤ Bb/L ≤ 0.5 may be satisfied. Accordingly, the effect of improving warpage strength and suppressing cracks according to the embodiment may be improved.

When Lp/L is less than 0.4, impact or arc discharge may occur between the external electrodes 131 and 132. When Lp/L exceeds 0.7, it may be difficult to fill the region in which warpage stress occurs the most with conductive resin layers.

When Bb/L is less than 0.1, it may be difficult to fill the region in which warpage stress occurs the most with the conductive resin layers 131b and 132b. When Bb/L exceeds 0.5, the thickness of the external electrode may increase, such that capacitance per unit volume may be lowered or equivalent series resistance (ESR) may increase.

Referring to FIG. 4, Lp, Bb, and L may be measured in the L-T cross-section.

Specifically, the L-T cross-section may be exposed by polishing the central portion of the body in the width direction, the length from the extension line E3 of the third surface to the extension line E4 of the fourth surface may be designated as the length L of the body, and the length measured from the center in the thickness direction of the protrusion PP may be designated as the length Lp of the protrusion. Also, Bb1, the length of the region in which the conductive resin layer 131b of the first external electrode is in contact with the second surface, and Bb2, and the length of the region in which the conductive resin layer 132b of the second external electrode is in contact with the second surface, may be measured, and the sum of Bb1 and Bb2 may be designated as Bb.

Also, Ba1, the length of the region in which the electrode layer 131a of the first external electrode is in contact with the second surface, and Ba2, the length of the region in which the electrode layer 132a of the second external electrode is in contact with the second surface, may be measured, and the sum of Ba1 and Ba2 may be designated as Ba.

Also, when the length from the extension line E3 of the third surface to the protrusion PP is defined as Bp1, and the length from the extension line E4 of the fourth surface to the protrusion PP is defined as Bp2, equation Bp1 + Bp2 + Lp = L may be satisfied.

In an embodiment, when the average thickness of the protrusion PP is defined as tp, tp may be 50 μm or more. Accordingly, the effect of improving warpage strength according to the embodiment may be improved.

The average thickness tp of the protrusion PP may be the average of thicknesses in the first direction measured at 10 arbitrary points of the upper protrusion 117 or the lower protrusion 116 in the cross-section in the first and second directions.

In an embodiment, when the average thickness of the protrusion PP is defined as tp and the average thickness of the cover portions 112 and 113 is defined as tc, tp/tc may be 2.5 or more and 10 or less. Accordingly, the effect of improving warpage strength according to the embodiment may be improved.

The average thickness tc of the cover portions 112 and 113 may be an average value of thicknesses in the first direction measured at 10 arbitrary points of the upper cover portion 112 or the lower cover portion 113 in the cross-section in the first and second directions.

In an embodiment, tc/td may be 0.4 or more and 33 or less, and tp/tc may be 2.5 or more and 10 or less.

As disclosed herein, L, Lp, Ba, Bb, tp, and tc may be measured by a scanning electron microscope (SEM). Other methods and/or tools appreciated by one of ordinary skill in the art, even if not described in the present disclosure, may also be used.

Referring to FIG. 2, in an embodiment, the width Wp of the protrusion may be substantially equal to the width W of the body. One surface of the protrusion in the width direction may be coplanar with the fifth surface 5, and the other surface of the protrusion in the width direction may be coplanar with the sixth surface 6. As used herein, the expression “substantially the same” may refer to having the same width relative to the width compared therewith, as will be appreciated by those of skill in the art, and allows for approximations, inaccuracies and limits of measurement under the relevant circumstances. In one or more aspects, the term “substantially” may provide an industry-accepted tolerance for their corresponding terms and/or relativity between items, such as a tolerance of ± 1%, ± 5% , or ± 10% of the actual value stated, and other suitable tolerances.

In an embodiment, when the length of the region of the second surface in contact with the electrode layer is defined as Ba, Ba may be smaller than Bb. Accordingly, the effect of improving warpage strength according to the embodiment may be improved.

In an embodiment, Ba and L may satisfy Ba/L≤0.2. When Ba/L exceeds 0.2, Bb may not be sufficiently secured, such that the effect of improving warpage strength may be insufficient.

In an embodiment, the protrusion PP and the dielectric layer 111 may include the same main component. Since the protrusion PP and the dielectric layer 111 include the same main component, the bonding strength between the body and the protrusion may be improved, and the body and the protrusion may be manufactured by sintering simultaneously.

The main component included in the protrusion PP and the dielectric layer 111 may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). Here, the main component may indicate that the content of the main component is 70 wt% or higher among the total components.

However, an embodiment thereof is not limited thereto, and the protrusion PP may be formed using a material having electrically insulating properties.

The method of forming the protrusion PP may not be limited to any particular example. Referring to FIG. 6 illustrating the body and the protrusion in an exploded manner, the plurality of dielectric material sheets satisfying the width and the length of the protrusion may be laminated on the cover portions 112 and 113, thereby forming the protrusions 116 and 117.

The external electrodes 131 and 132 may be disposed on the body 110 and may include electrode layers 131a and 132a and conductive resin layers 131b and 132b.

The external electrodes 131 and 132 may include first and second external electrodes 131 and 132 connected to first and second internal electrodes 121 and 122, respectively.

The first external electrode 131 may include the first electrode layer 131a and the first conductive resin layer 131b, and the second external electrode 132 may include the second electrode layer 132a and the second conductive resin layer 132b.

The first and second electrode layers 131a and 132a may be formed using any electrically conductive material, such as metal, and the specific material may be determined based on factors such as electrical properties and structural stability.

For example, the first and second electrode layers 131a and 132a may include a conductive metal and glass.

The conductive metal used in the electrode layers 131a and 132a is not limited to any particular example as long as the metal may be electrically connected to the internal electrode to form electrostatic capacitance. For example, the conductive metal may include one or more selected from a group consisting of nickel (Ni), copper (Cu), palladium (Pd), silver (Ag), gold (Au), platinum (Pt), tin (Sn), tungsten W, titanium (Ti), and alloys thereof.

The electrode layers 131a and 132a may be formed by applying a conductive paste prepared by adding glass frit to the conductive metal powder and firing the paste.

Also, the first and second electrode layers 131a and 132a may be formed using a plating process, an atomic layer deposition (ALD) process, a molecular layer deposition (MLD) process, a chemical vapor deposition (CVD) process, a sputtering process, or the like.

Also, the first and second electrode layers 131a and 132a may be formed by transferring a sheet including a conductive metal onto the body 110.

The conductive resin layers 131b and 132b may include a conductive metal and resin.

The conductive metal included in the conductive resin layers 131b and 132b may be electrically connected to the electrode layers 131a and 132a.

The conductive metal included in the conductive resin layers 131b and 132b is not limited to any particular example as long as the metal may be electrically connected to the electrode layers 131a and 132a, and may include, for example, one or more selected from a group consisting of nickel (Ni), copper (Cu), palladium (Pd), silver (Ag), gold (Au), platinum (Pt), tin (Sn), tungsten W, titanium (Ti), and alloys thereof.

The conductive metal included in the conductive resin layers 131b and 132b may include one or more of spherical powder particles and flake powder particles. That is, the conductive metal may solely include flake powder particles, or solely include spherical powder particles, or may include a mixture of flake powder particles and spherical powder particles.

Here, the spherical powder may also include particles having a shape other than a spherical shape. For example, the shape having a length ratio (major axis/minor axis) may be 1.45 or less may be included.

The flake powder particles may indicate powder particles having a flat and elongated shape. For example, the length ratio of the major axis and the minor axis may be 1.95 or more, but is not limited thereto.

The length of the major and minor axes of the spherical powder and flake-shaped powder particles may be measured by scanning an image of the cross-section in the first and second directions cut at the central portion in the third direction of the multilayer electronic component using a scanning electron microscope (SEM).

Resin included in the conductive resin layers 131b and 132b may ensure bonding properties and may absorb impacts.

The resin included in the conductive resin layers 131b and 132b is not limited to any particular example as long as the resin has bonding properties and impact absorbing properties and may be mixed with the conductive metal powder to form a paste. For example, the resin may include one or more of an epoxy resin and an acrylic resin.

Also, the conductive resin layers 131b and 132b may include a conductive metal, an intermetallic compound, and a resin.

The external electrodes 131 and 132 may further include a plating layer disposed on the conductive resin layers 131b and 132b to improve mounting properties.

For example, the plating layer may be a Ni plating layer or a Sn plating layer, and a Ni plating layer and a Sn plating layer may be formed in order on the conductive resin layers 131b and 132b, and a plurality of Ni plating layers and/or a plurality of Sn plating layers may be included. Also, the plating layer may have a form in which a Ni plating layer and a Pd plating layer are formed in order.

The size of the multilayer electronic component 100 may not be limited to any particular example. For example, the size of the multilayer electronic component 100 may be 0603 (length×width, 0.6mm×0.3mm), 1005 (length×width, 1.0mm×0.5mm), 2012 (length×width, 2.0mm×1.2mm), 3216 (length×width, 3.2mm×1.6mm), 3225 (length×width, 3.2mm×2.5mm), 4532 (length×width, 4.5mm×3.2mm), 5750 (length×width, 5.7mm×5.0mm), or the like.

Hereinafter, embodiments will be described with reference to FIGS. 7 to 10. The second external electrode 132, 132’, 132’’, and 132’’’ may be symmetrical to the first external electrode 131, 131’, 131’’, and 131’’’. Thus, the first external electrode will be described, and the description of the second external electrode may not be provided.

Referring to FIG. 7, the electrode layer 131a may extend to the second surface, one end bea1 of the electrode layer may be positioned on the second surface, and one end beb1 of conductive resin layer 131b may be positioned at the edge of the protrusion 117.

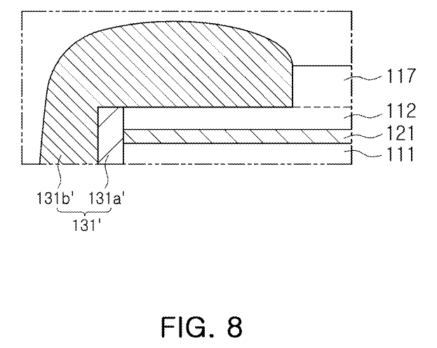

However, the electrode layers 131a and 132a may not necessarily extend to a portion of the first and second surfaces as illustrated in FIGS. 2 and 7. Referring to FIG. 8 corresponding to FIG. 7 according to an embodiment, the conductive resin layer 131b’ of the external electrode 131’ may be disposed as in FIG. 7, and the electrode layer 131a’ may not extend to the first and second surfaces 1 and 2. Accordingly, by ensuring the region in which the conductive resin layer 131b’ of the external electrode 131’ is in contact with the second surface, warpage strength may be improved.

In this case, the electrode layer 131a’ may be formed by transferring a sheet including conductive metal and glass. Also, the electrode layer 131a’ may be a plating layer formed by a plating process, or a layer formed by a deposition process such as sputtering or atomic layer deposition (ALD).

The electrode layer 131a’ of the external electrode 131’ may be disposed to cover the entire third surface, but an example embodiment thereof is not limited thereto. For example, the electrode layer 131a’ may cover a region of the third surface in which the internal electrode 121 is exposed, and may not be disposed on at least a portion of a region of the third surface in which the internal electrode 121 is not exposed.

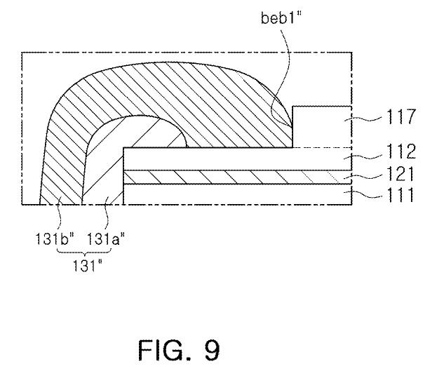

Also, in FIG. 7, the conductive resin layer 131b may be disposed to completely cover one surface in the length direction of the protrusion. However, referring to FIG. 9 corresponding to FIG. 7 according to another embodiment, the electrode layer 131a’’ of the external electrode 131’’ may be disposed in the same manner as in FIG. 7, but the conductive resin layer 131b’’ may be disposed to cover only a portion of one surface in the length direction of the protrusion, and one end beb1’’ of the conductive resin layer 131b’’ may be positioned on one surface in the length direction of the protrusion.

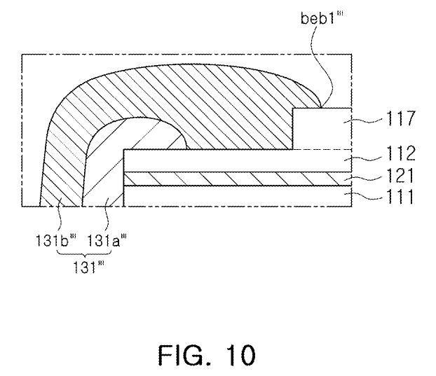

Also, referring to FIG. 10 corresponding to FIG. 7 according to another embodiment, the electrode layer 131a’’’ of the external electrode 131’’’ may be disposed in the same manner as in FIG. 7, but the conductive resin layer 131b’’’ may be disposed to cover a portion of the external surface in the thickness direction of the protrusion. In this case, one end beb1’’’ of the conductive resin layer 131b’’’ may be positioned on the external surface in the thickness direction of the protrusion.

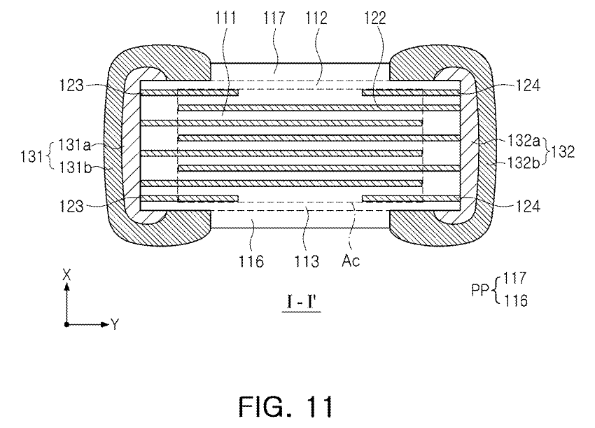

FIG. 11 is a diagram corresponding to FIG. 4, in which a dummy electrode is added, according to an embodiment.

Referring to FIG. 11, the body 110 may include a capacitance formation portion Ac including internal electrodes 121 and 122 disposed alternately with a dielectric layer in the thickness direction, and cover portions 112 and 113 disposed above and below the capacitance formation portion in the thickness direction, respectively, external electrodes 131 and 132 may include a first external electrode 131 disposed on the third surface and a second external electrode 132 disposed on the fourth surface, and the capacitance formation portion Ac may further include a first dummy electrode 123 disposed between the cover portions 112 and 113 and the internal electrode disposed in the outermost region in the thickness direction and connected to the first external electrode, and the second dummy electrode 124 disposed to face the first dummy electrode in the length direction and connected to the second external electrode.

The dummy electrodes 123 and 124 may prevent reliability degradation due to shorts and arc between the internal electrode and the external electrode.

When dummy electrodes 123 and 124 are not disposed, the internal electrode may be extremely close to the external electrode of opposite charge, reliability may degrade due to shorts and arc.

According to the aforementioned embodiments, by disposing a conductive resin layer in a portion vulnerable to warpage strength by disposing the protrusions on the first and second surfaces of the body, warpage strength may be improved.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes alternately disposed with the dielectric layer in a thickness direction, the body including first and second surfaces opposing each other in the thickness direction, third and fourth surfaces connected to the first and second surfaces and opposing each other in a length direction, and fifth and sixth surfaces connected to the first to fourth surfaces and opposing each other in a width direction;
a protrusion disposed on the first and second surfaces; and
an external electrode disposed on the third and fourth surfaces and extending to the protrusions,
wherein the external electrode includes an electrode layer connected to the internal electrodes, and a conductive resin layer disposed on the electrode layer, the conductive resin layer including a conductive metal and resin, and
wherein the electrode layer is spaced apart from the protrusion, and the conductive resin layer is disposed to be in contact with the protrusion.

2. The multilayer electronic component of claim 1, wherein, when a length of the body is defined as L, a length of the protrusion is defined as Lp, and a length of a first region of the second surface in contact with the conductive resin layer is defined as Bb, 0.4 ≤ Lp/L ≤ 0.7 and 0.1 ≤ Bb/L ≤ 0.5 are satisfied.

3. The multilayer electronic component of claim 1,
wherein the body includes a capacitance formation portion including the internal electrodes alternately disposed with the dielectric layer in the thickness direction, and a cover portion disposed on surfaces of the capacitance formation portion opposing each other in the thickness direction, and
wherein, when an average thickness of the cover portion is defined as tc, tc is 10μm or more and 200μm or less.

4. The multilayer electronic component of claim 1,
wherein the body includes a capacitance formation portion including the internal electrodes alternately disposed with the dielectric layer in the thickness direction, and a cover portion disposed on surfaces of the capacitance formation portion opposing each other in the thickness direction, and
wherein, when an average thickness of the dielectric layer is defined as td and an average thickness of the cover portion is defined as tc, tc/td is 0.4 or more and 10 or less.

5. The multilayer electronic component of claim 1, wherein, when an average thickness of the protrusion is defined as tp, tp is 50μm or more.

6. The multilayer electronic component of claim 1,
wherein the body includes a capacitance formation portion including the internal electrodes alternately disposed with the dielectric layer in the thickness direction, and a cover portion disposed on surfaces of the capacitance formation portion opposing each other in the thickness direction, and
wherein, when an average thickness of the protrusion is defined as tp and an average thickness of the cover portion is defined as tc, tp/tc is 2.5 or more and 10 or less.

7. The multilayer electronic component of claim 1, wherein a width of the protrusion is substantially the same as a width of the body.

8. The multilayer electronic component of claim 2, wherein, when a length of a second region of the second surface in contact with the electrode layer is defined as Ba, Ba is smaller than Bb.

9. The multilayer electronic component of claim 8, wherein Ba and L satisfy Ba/L≤0.2.

10. The multilayer electronic component of claim 1, wherein the electrode layer does not extend to the first and second surfaces.

11. The multilayer electronic component of claim 1, wherein an end of the conductive resin layer is positioned on a surface of the protrusion in the length direction.

12. The multilayer electronic component of claim 11, wherein a portion of the surface of the protrusion on which the conductive resin layer is not positioned is exposed, and
wherein the electrode layer includes copper.

13. The multilayer electronic component of claim 1, wherein an end of the conductive resin layer is positioned on an external surface of the protrusion in the thickness direction.

14. The multilayer electronic component of claim 1, wherein the protrusion and the dielectric layer include the same main component, and the main component includes one or more selected from the group consisting of BaTiO₃ (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

15. The multilayer electronic component of claim 1,
wherein the body includes a capacitance formation portion including the internal electrodes alternately disposed with the dielectric layer in the thickness direction, and a cover portion disposed on surfaces of the capacitance formation portion opposing each other in the thickness direction, and
wherein, when an average thickness of the protrusion is defined as tp, an average thickness of the dielectric layer is defined as td, and an average thickness of the cover portion is defined as tc, tc/td is 0.4 or more and 33 or less, and tp/tc is 2.5 or more and 10 or less.

16. The multilayer electronic component of claim 1,
wherein the body includes a capacitance formation portion including the internal electrodes alternately disposed with the dielectric layer in the thickness direction, and a cover portion disposed on surfaces of the capacitance formation portion opposing each other in the thickness direction,
wherein the external electrode includes a first external electrode disposed on the third surface and a second external electrode disposed on the fourth surface, and
wherein the capacitance formation portion further includes a first dummy electrode disposed between the cover portion and an internal electrode, among the internal electrodes, disposed in an outermost region in the thickness direction and connected to the first external electrode, and a second dummy electrode opposing the first dummy electrode in the length direction and connected to the second external electrode.

17. The multilayer electronic component of claim 1, wherein the protrusion is disposed only on the first and second surfaces.

18. A method of manufacturing the multilayer electronic component of claim 1, comprising:
stacking a plurality of ceramic green sheets to form a stack, wherein at least one ceramic green sheet among the plurality of ceramic green sheets includes a surface on which a layer of first conductive metal is disposed, and
stacking a dielectric material sheet having a length shorter than a length of the stack on surfaces of the stack that oppose each other in a stacking direction.

19. The method of claim 18, wherein the dielectric material includes at least two dielectric material sheets.

20. The method of claim 18, further comprising:
sintering the dielectric material sheet on the stack to form the protrusion and the body,
applying a second conductive metal on the body to form the external electrode.
